(19) United States
(12) Patent Application Publication
(10) Pub. No.: US 2013/0231856 A1
(43) Pub. Date: Sep. 5, 2013

(54) METHOD AND DEVICE FOR FAST LOCALIZATION OF OBJECTS (E.G. VEHICLES) MOVING TOWARD A TARGET OBJECT

(71) Applicants: Dieter Bachmann, Feldkirch (AT); Vincent Chauvin, San Jose, CA (US)

(72) Inventors: Dieter Bachmann, Feldkirch (AT); Vincent Chauvin, San Jose, CA (US)

(21) Appl. No.: 13/599,204

(22) Filed: Aug. 30, 2012

(30) Foreign Application Priority Data
Sep. 1, 2011 (DE) 10 2011 111 976.4

(51) Int. Cl. G01C 21/28

(52) U.S. Cl. CPC G01C 21/28
USPC 701/409

(57) ABSTRACT

A method for the fast localization of objects (e.g. vehicles) moving toward a target object in a space illuminated by means of radio beacons, through which the current GPS coordinates of the moving object and the target object are known, and the moving object receives a work order from a stationary server device and a business application loaded therein, at least to the extent that it is to move toward the position of the target object given in the work order, wherein a measurement of the distance from the object being driven to the radio beacons is carried out, and that a comparison between the transmitted position data of the target object and the current actual position of the object being driven is carried out in the object being driven until the difference (between the actual value and the target value) has fallen below a certain threshold value.

With an object moving through space, which is to move to a certain target position in order to execute an action, there is the problem that the localization and the feedback indicating that the object has arrived at the target position (e.g. in order to authorize the relevant action) are too slow.

The determination of the position is carried out by means of a measurement of the distance from the object to location beacons, the spatial location of which have been determined. The measurement method used between the object and the position beacon can, for example, be a time measurement, a measurement of the time difference, a distance measurement, a measurement of the signal strength, or a combination thereof. The position determined in this manner can be converted to GPS coordinates.

This position is subsequently processed in a server-side business application, in order to make a position dependent decision (has, e.g. the object arrived at the target position and is the action permissible at this position?)

In a harbor, the moving object may, for example, be a mobile crane, and the action would be the lifting of a container. At the moment in which the mobile crane is located above the container, the taking hold of, and lifting of the container is authorized.

The disadvantage with this prior art is, however, that the time required for the localization of the object being driven, including the calculation of the current position and the supplying of the determined position data to the business application is afflicted with a time period of, e.g. 3.5 seconds or more.

This is not sufficient, however, for providing the object with a fast feedback and for authorizing the action that is demanded thereof (e.g. the lifting of a container), without noticeably delaying the process.

The server calculates the position of the vehicle by means of the location readings. This position is checked in the business application against the current work order of the vehicle, and the corresponding feedback (e.g. the position has been reached, the container is to be deposited, is authorized) is transmitted to the vehicle. Because of the system taking part in the procedure, and the time required for the transmission of the data, a delay of over 10 seconds may occur before the process (loading operation) is completed.

In other words, very long time periods are required for the calculation and the decision, which poses a disadvantage.

The invention therefore assumes the objective of significantly reducing the duration of the localization confirmation and the authorization of an action for an object that is moving.

In order to attain this proposed objective, the invention is characterized by the technical teachings of Claim 1.

The substantial characteristic of the invention is that the target coordinates, to which the object being driven is to move, are already known prior to executing the work order (e.g. for a harbor system). If, for example, a certain container is detected in row 5, column 10 and elevation 8, then its coordinates (e.g. in the form of GPS coordinates) are precisely known in the harbor system and the business application.

In this case, it is known that the operator of the harbor crane or similar item is not in possession of the absolute GPS position, but instead, a relative, logical object position (e.g. row 5, column 8, elevation 0); he therefore receives logical coordinates.

In so doing, the target coordinates of the target object are stored in the server in advance, such that both the logical position as well as the GPS coordinates are available in the server.

The GPS coordinates in the server are converted to distance values, such that said GPS coordinate-defined distances to the stationary location beacons are calculated as a geometric distance in the harbor space. These distance values are converted in the respective localization procedure from the determined measured values (e.g. time measurement, measurement of the time difference, distance measurement, measurement of the signal strength, or a combination thereof; see above).

The measured values calculated in this manner are provided to the object being driven, which has received a work order pertaining thereto, instructing said object to move to the position in column 10, row 8, and elevation 5, for example, in order to pick up a container there. At the same time, the location readings of the distance to the position beacon, or to the reference points at the target position that have been previously calculated as permanently established values, are transmitted to the object being driven.

After the transmission, the object being driven continuously determines the distances to the stationary radio beacon, wherein the current distances are no longer transmitted to the stationary (e.g. harbor) server for processing and deciding, but instead, the object being driven itself determines the deviation, or the error between the current locations and the location of the target.

The computed error is a measurement for the distance from the object to the target coordinates. It is important that the result of the error calculation be a value (e.g. a scale) which one can use for comparison, readily and without extensive computing operations.

The size of the error is determined by means of a standard mathematic formula for geometric errors, e.g. in the form of a mean square error (MSE) or the root of the mean square error (RMSE). The method for determining the error is not decisive. In this respect, it is important that the calculation method not require a great deal of computing, and that the error decreases as the target position is approached.

Examples for the error calculation are given below:

### MSE:

mi . . . Location reading from the object to a location beacon
pi . . . pre-calculated target location reading from the object to a location beacon
N . . . Number of measurements

MSE=sum1 . . . N((mn−pn)2)/N

### RMSE:

RMSE=SQRT(MSE)

For the decision, of whether the object has arrived at the target, the error is checked against a threshold value. The respective selected threshold value is dependent on the respective measurement method, the error method and on the required precision of the positioning at the target.

Therefore, a decentralized measurement of the distance from the object being driven to the stationary beacon is made, and a local comparison with the transmitted data of the target object is carried out in the object being driven itself. It is important that the object itself, as soon as the calculated error is less than a previously defined threshold, can decide that the target position has been reached.

This results in there no longer being a need for external server assistance, and no need for lengthy computing time, because the actual decision takes place in the moving object itself, specifically by means of the calculation of the error between the readings for the current position, and the target readings at the target position.

It is therefore decisive with the invention, that from a known target GPS position of the moving object, readings are derived through a reverse calculation, and that furthermore, the (distance) error is continuously calculated in the object being driven itself, and continuously compared there to the threshold value.

The advantage of the invention is that at the point in time of the decision for the execution of the work order in the vehicle being driven, an external computing assistance from the stationary server, which is associated with a computing intensive business application, is no longer required.

The data are pre-processed to the extent that the entire distance measuring and the decisions pertaining thereto take place in a decentralized manner in the object being driven, and are carried out in real-time.

### EXAMPLE

### Procedural Steps

Step 1: The business application decides that the work order is to be sent to the operator of the moving object.

Step 2: The target location readings (at the target position) are calculated in the stationary server from the GPS coordinates of the target position.

The work order therefore consists of a portion being for the operator, and a portion being for the system in the vehicle, which regulates the execution of the work order.

Step 3: The work order is sent to the vehicle.

Step 4: The operator receives, in his display, only the notification that he is to drive to lane 35, row 18 and elevation 5 in the grid system of the harbor, in order to pick up a container there.

Step 5: The operator begins driving as soon as the work order from step 4 has been received, without waiting for further information, or downloading further data from a server, which in some circumstances would require significant computing time.

Step 6: At the same time, readings for the reference points are continuously carried out in the object being driven, and the current error (between the measured location values and the target location values) is calculated.

Step 7: As soon as the object being driven has arrived at the location of the target object, all comparison values from the error distance measurement according to step 6 approach zero.

As soon as the threshold value for the error is no longer exceeded, the operator receives a visual confirmation that he has arrived at the target object.

Step 8: At the same time, the corresponding action (e.g. picking up the container) is authorized. An electronic monitoring regarding the loading operation takes place therefore, in order to prevent the operator from picking up the wrong container.

With the invention, the normally occurring procedural time periods are avoided: a decision is made quickly, in a decentralized manner, and the delay for the authorization is significantly shortened thereby. It is decisive that all time-critical calculations are made in real-time in the object being driven.

The normal procedural time periods are shortened, which basically take place as follows:

A vehicle is equipped with a tag for localization. This tag measures the distance to the reference points and transmits the information via radio signals to a server. Said server calculates the position of the vehicle from the location readings. This position is checked against the current work order of the vehicle in the business application, and a corresponding feedback (e.g. position arrived at, deposit container, is authorized) is transmitted to the vehicle.

Due to the system taking part in the procedure, and the transmission times for the data, a delay of over 10 seconds may occur before the procedure (uploading operation) is completed.

In order to avoid this undesired lengthy computing time, the invention now provides that the work order, together with the target position, and the pre-calculated location readings at the target position, are delivered in advance to the object being driven at a certain point in time. There is therefore sufficient time in which to execute the necessary computing operations at an external server. In executing the work order, all of the data necessary for a fast decision are already present in the moving object.

As a result of the decentralized decision making taking place in the moving object, substantial procedural times are eliminated accordingly. The extensive computations are removed from the time-critical portion of the procedure, and executed prior to starting the procedure (work order). One already prepares the decision long in advance and then decides on a short-term basis. The extensive computations therefore no longer take place during the critical phase. This method therefore functions, when prior to the starting of the procedure, it is already known what the moving object is supposed to do, even though the object still requires a long time in which to do so.

If for example, one drives a vehicle at 30 km/h, and said vehicle is to cover a distance of 2 km, one has enough time during the driving period of 10 minutes, in which to prepare the work order and the ensuing decision, with all of the calculations pertaining thereto, during the driving period. As a result, the operator receives authorization for the picking up or depositing of a container as soon as the moving object arrives at its target, without having to wait for a calculation and authorization provided by an external server.

This is a substantial difference with respect to the prior art, because with the prior art, it has been known until now that the calculation of the coordinates is executed based on the location readings of the moving object, and all of the computation, or respectively, decisions resulting therefrom, are first carried out when the moving object has arrived at the target object. The invention avoids this.

It is important with the invention that the error determination routine carried out in the moving object runs for a time period that is as short as possible, i.e. it does not require an extensive computing time, because otherwise, the advantages of the prior art would still exist, in that time would be used for calculations, which one is actually trying to avoid. The algorithm for the error calculation can be made such that it is dependent on the application, and on the type of distance measurement. For this reason, there are different possibilities for executing an error correction routine of this type.

(See Above Examples: MSE, RMSE)

The error calculation takes place, however, in the moving object, and for this reason it must be possible to do so with a limited computing expenditure.

It is important that the present invention is not limited to one position, but can simultaneously process numerous target positions, or a zone. It is therefore decisive that, due to the short computing times, multiple targets, or even zones, can also be computed and approached. By way of example, the harbor crane could also receive a work order for picking up any one of 3 available containers, and then the other two remaining containers, successively.

The invention, however, is not limited to moving objects in the form of a harbor crane or similar item. The moving object can also be a person with a portable display, who carries out certain work orders. Likewise, numerous people can work with the method according to the invention.

The invention may be used on a planar surface (2D) or spatially (3D).

The subject matter of the invention for the present invention is derived not only from the subject matter of the individual Claims, but also from the various combinations of the individual claims.

All of the information and characteristics disclosed in the documents, including the abstract, in particular the spatial design depicted in the drawings, are claimed as substantial to the invention, insofar as they are novel, individually, or in combination, with respect to the prior art.

In the following, the invention shall be explained in greater detail based on drawings depicting only one means of execution. In so doing, further characteristics and advantages substantial to the invention are to be derived from the drawings and the descriptions thereof.

They show:

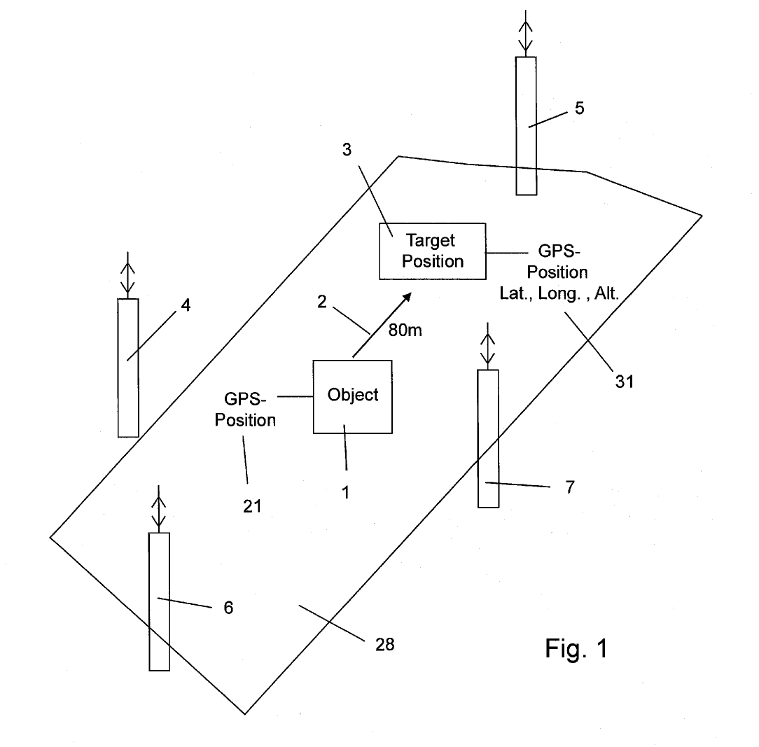

FIG. 1: a schematic depiction of the method,

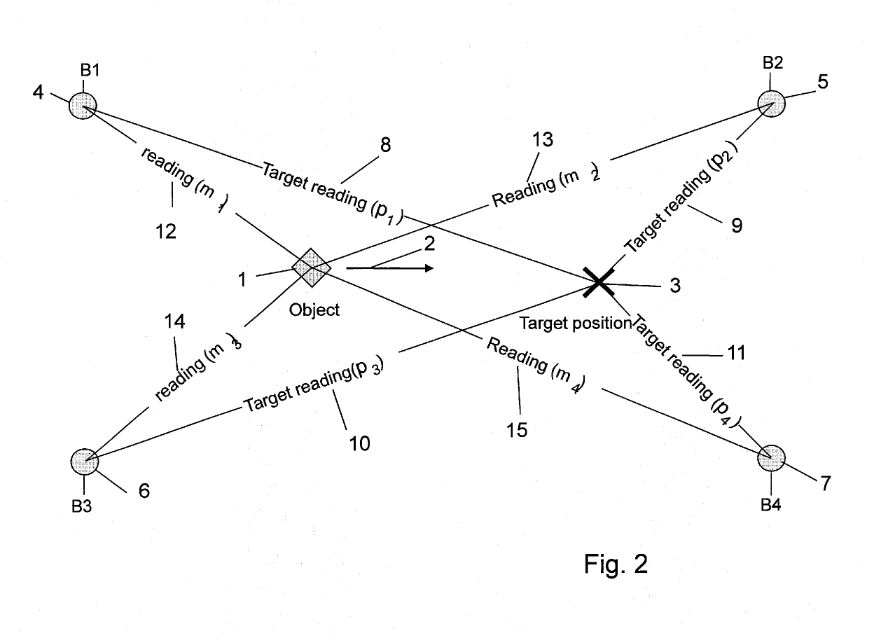

FIG. 2: the same depiction as that in FIG. 1, with a depiction of the determined location readings,

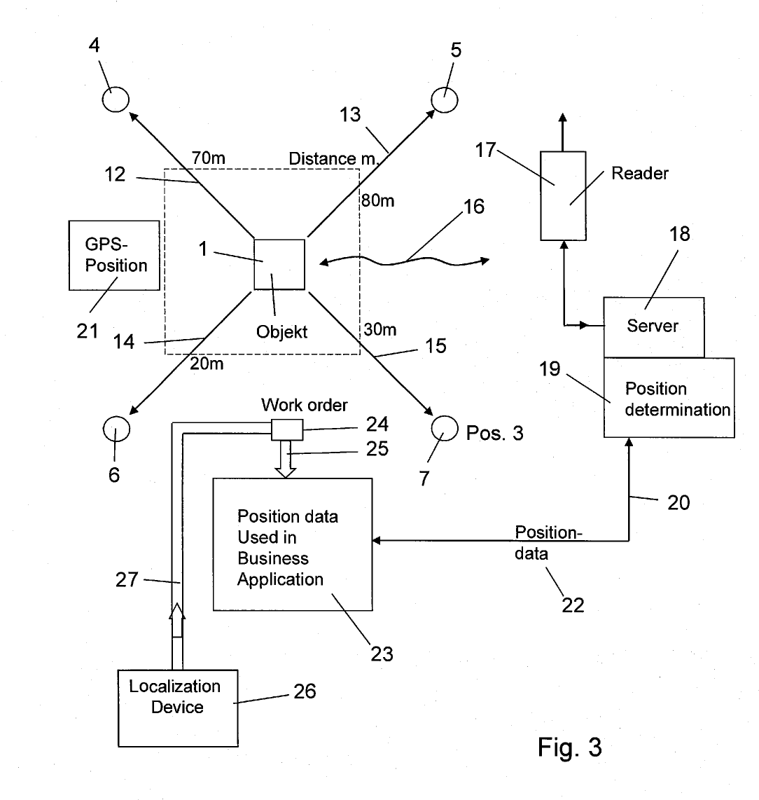

FIG. 3: a schematic depiction of the method according to FIGS. 1 and 3 with other devices,

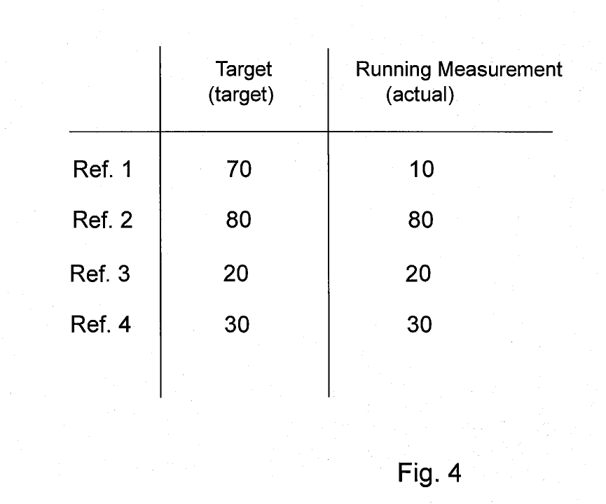

FIG. 4: a recording as a specific moment of the determination of the distance to the individual radio beacon during the driving operation of the moving object,

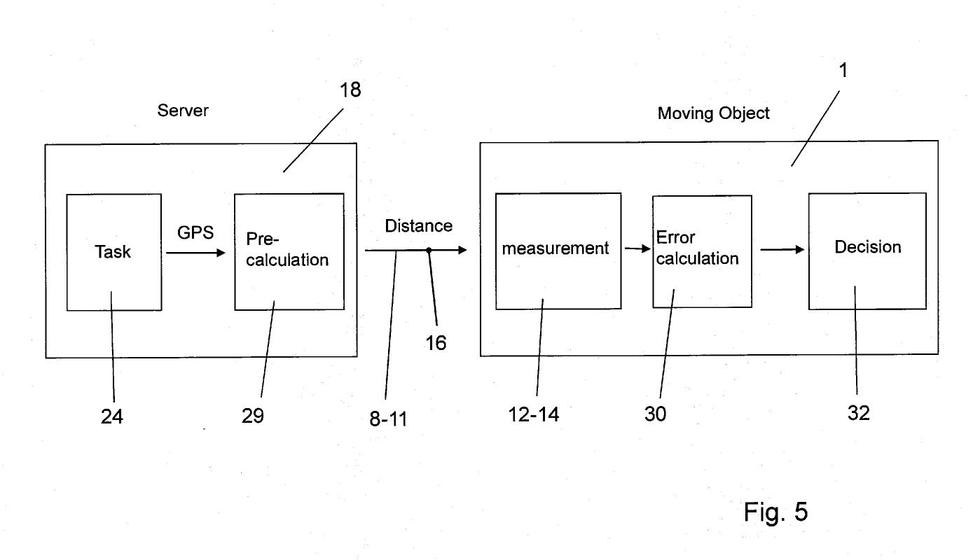

FIG. 5: a process design for data collection between the server and the moving object,

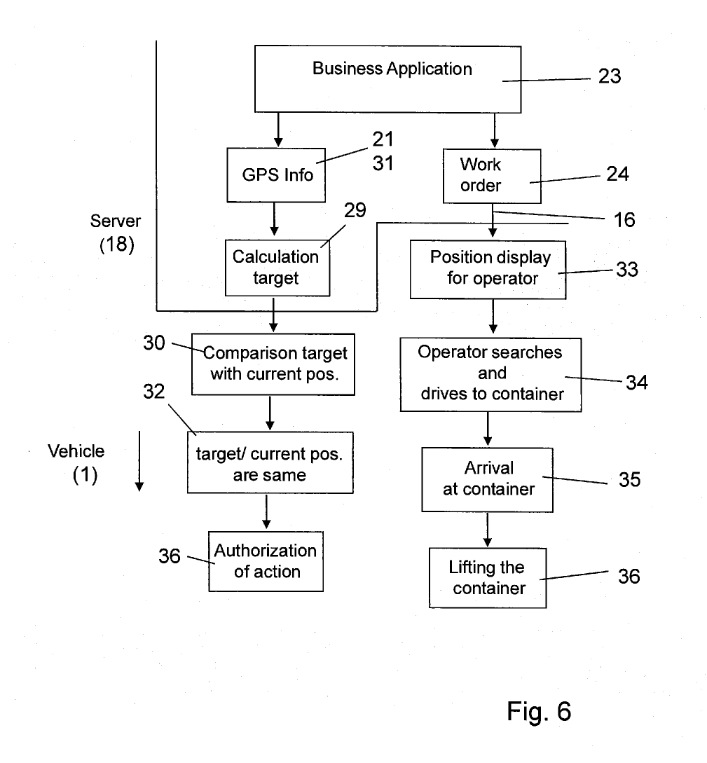

FIG. 6: a flow chart for the execution of the method.

In a spatially fixed, defined space 28, e.g. a harbor space, radio beacons 4, 5, 6, 7 are disposed at regular intervals on the border of the space 28, which can execute distance measurements on an object 1 moving in the space 28. The object 1 has a particular current GPS position 21 and moves, by way of example, in the direction of the arrow 2 toward a target object 3. The target object 3 has, for example, the GPS position 31.

According to FIG. 2, a continuous measurement takes place between each radio beacon 4-7 with respect to the object 1 moving in the direction of the arrow 2, by means of which the actual location readings 12-15 are generated.

At the same time, however, the target position of the target object 3 is known, in which the target location readings 8-11 of the target object 3 are disposed.

The detection of the target coordinates of the target object 3 by means of downloading the target location readings 8-11 can be carried out a long time prior to the execution of a work order, and a long time prior to the start-up of the object 1.

According to FIG. 3, a continuous distance measurement and downloading of the actual location readings 12-15 takes place in relation to the moving object 1, wherein said location readings are sent via a communication connection 16, which is preferably wireless, to a stationary reader 17, which is connected to a stationary server 18.

The server 18 is connected to a device for position determination 19, in which the current actual coordinates of the moving object 1 are calculated, which are sent to the business application 23 via a data link 20 in the form of position data 22.

Said business application is a software program, which is administered in the server 18, and which receives data from a localization device 26 via a data link 27.

All current location positions (target location readings 8-11) for each arbitrary target object 3 in the space 28 are stored in the localization device 26.

Thereby, a work order 24 for the moving object 1 is uploaded in the business application 23, and stored, via a data link 25, in the business application 23.

The current position of the object 1 in the space is thus determined in the formula according to FIG. 3, and furthermore, the distance is from the object 1 to the target object 3 is determined thereby.

These data are sent to the reader 17 via the data link 20, which transmits the work order 24 generated by the business application 23 to the moving object 1 via the communication connection 16.

At the point in time of the transmission of the work order, the error table depicted in FIG. 4, by way of example, applies. It can be seen therein that the target object with respect to the radio beacon 4 is at a distance of 70 m, with respect to the radio beacon 5, is at a distance of approx. 80 m, and with respect to the radio beacons 6 an 7, is at distances of 20 and 30 m respectively.

Similarly, this table indicates that the current position of the moving object 1 is at a distance of 10 m from the radio beacon 4, 80 m from the radio beacon 5, 20 m from the radio beacon 6, and 30 m from the radio beacon 7.

FIG. 5 again shows in a schematic manner the generation of the work order 24 in the stationary server 18, wherein the work order 24 is converted using the current GPS coordinates of the target object 3 in a preliminary calculation step 29 to distance values, and said distance values are sent to the moving object 1 as target location readings 8-11 via the communication connection 16.

For this reason, a continuous detection of the current actual location readings 12-14, and a comparison with the target location readings 8-11 of the target object, takes place in the moving object 1, and from this an error calculation step 30 is triggered, in which the deviations between the actual position and the target position are calculated according to FIG. 4.

With reference to FIG. 4, the error with respect to the radio beacon 4 is given a difference value of 60 m for this reason, with respect to radio beacon 5, a difference error of zero, and with respect to radio beacon 3, also a difference error of zero, and with respect to radio beacon 4, also a difference error of zero.

This means that the moving object 1 must only move in a certain direction with respect to radio beacon 4, in order to bring the existing difference error with respect to a predetermined threshold value to within the proximity of zero.

FIG. 6 shows a flow chart for the method according to the invention, wherein, based on the business application 23, first the target location readings for the target object are detected as GPS positions 31, and at the same time the current GPS position 21 of the object 1 is known, and it is decided in a preliminary calculation step 29 which moving object is to receive the work order 24.

This is transmitted to the moving object 1 via the communication connection 16 and displayed on a display screen 33.

The operator can, therefore, begin driving, and by means of observing the display screen 33, immediately begin to search for the target object, as the moving object 1 first moves with a large error deviation toward the target object 2, while said error, however, approaches zero as the target object 3 is approached.

In block 35, an optical signal is provided to the operator, indicating the arrival at the target object 3, and in block 36, he receives the authorization for the execution of the work order.

A difference calculation, between the target location readings 8-11 of the target object and the actual location readings 12-15 of the moving object, takes place continuously in the error calculation step 30, in the moving object itself, and based on this, a threshold value is created. As soon as this threshold value approaches zero, the decision step 32 is triggered. This activates an electronic checking routine via a data link, which decides whether or not the work order should now be executed, and then authorizes said work order.

Reference Symbol Key for the Drawings

| | |
|---|---|
| 1 | object |
| 2 | direction of arrow |
| 3 | target object |
| 4 | beacon 1 |
| 5 | beacon 2 |
| 6 | beacon 3 |
| 7 | beacon 4 |
| 8 | target location reading p1 |
| 9 | target location reading p2 |
| 10 | target location reading p3 |
| 11 | target location reading p4 |
| 12 | actual location reading m1 |
| 13 | actual location reading m2 |
| 14 | actual location reading m3 |
| 15 | actual location reading m4 |
| 16 | communication connection |
| 17 | reader |
| 18 | server |
| 19 | position determination |
| 20 | data link |
| 21 | GPS position (of object 1) |
| 22 | position data |
| 23 | business application |
| 24 | work order |
| 25 | data link |
| 26 | localization device |
| 27 | data link |
| 28 | space |
| 29 | preliminary calculation step |
| 30 | error calculation step |
| 31 | GPS position (of target 3) |
| 32 | decision step |
| 33 | display screen (in object 1) |
| 34 | drive search |
| 35 | arrival |
| 36 | execution of work order |

1. A method for the fast localization of objects (1) (e.g. vehicles) moving toward a target object (3) in a space (28) illuminated by means of radio beacons (4-7), through which the current GPS coordinates (21, 31) of the moving object (1) and the target object (3) are known, and the moving object (3) [sic: should be (1)] receives a work order (24) from a stationary server device (18) and a business application (23) loaded therein, at least to the extent that it is to move toward the position of the target object (3) given in the work order, characterized in that a measurement of the distance from the object (1) being driven, to the radio beacons (4-7) is carried out in the object (1) being driven, and that a comparison between the transmitted position data of the target object (3) and the current actual position of the object (1) being driven is carried out until the difference (between the actual value and the target value) has fallen below a certain threshold value.

2. The method according to claim 1, characterized in that the calculation of the difference between the actual position and the target position takes place in the object (1) being driven itself, and that the moving object (1) itself makes a decision as soon as the calculated error lies below a previously defined threshold value, which indicates that the target position (31) of the target object (3) has been reached.

3. The method according to claim 1, characterized in that the target coordinates (31) of every arbitrary target object (3) in the space (28) are stored in advance in a stationary server (18), that the GPS coordinates (31) of the target object (3) are converted in the server (18) to distance values, such that distances to the stationary radio beacons (4-7) defined in the space (28) can be calculated from the GPS coordinates as geometric distances, that the measured values calculated in this manner can be transmitted to the object (1) being driven the context of a work order (24) and that the object (1) being driven can calculate for itself, during its drive toward the target object (3), the deviation, or respectively, the error between the current driving position and the target position, and from this a difference is calculated, which is compared against the threshold value.

4. The method according to claim 1, characterized in that a location reading is calculated in reverse from a known target position (31) of the target object (3) and the GPS position (21) of the moving object (1), and that furthermore, the (distance) error is continuously calculated in the object (1) being driven, and continuously compared there to the threshold value.

5. The method according to claim 1, characterized by the following procedural steps:
Step 1: The business application (23) loaded in the server (18) decides that a work order (24) is to be sent to the operator of the moving object (1).
Step 2: The target location readings (at the target position) are calculated from the GPS coordinates (31) in the stationary server (18), wherein the work order (24) consists in part for the operator, and in part for the system in the moving object (1), which regulates the execution of the work order.
Step 3: The work order (24) is transmitted to the moving object (1).
Step 4: The operator receives a notification on his display that he is to drive in the grid system of the space to a logical position (e.g. track 35, row 18, and elevation 5) of the target object (3), and execute the work order (e.g. pick up a container) there.
Step 5: After receiving the work order from step 4, the operator begins driving, without waiting for further information, or downloading further data from a server (18).
Step 6: Continuous distance measurements with respect to the stationary reference points (radio beacons 4-7) are carried out during the drive in the object (1) being driven, and the current errors (between the actual location readings and the target location readings) are calculated in the moving object (1) and compared against the predetermined threshold value.
Step 7: As soon as the object (1) being driven arrives at the location of the target object (3), the threshold value, in the form of the result of the error distance measurement from step 6, approaches zero; as soon as the threshold value falls below a predetermined value, the operator receives a visual confirmation that he has arrived at the target object (3).
Step 8: At the same time, the work order (24) (e.g. pick up container) is authorized, and an electronic monitoring with respect to the work order (e.g. loading operation) takes place, in order to prevent the operator from carrying out the wrong work order (e.g. picking up the wrong container).

6. An apparatus for the fast localization of objects (1) (e.g. vehicles) moving toward a target object (3) in a space (28) illuminated by means of radio beacons (4-7), through which the current GPS coordinates (21, 31) of the moving object (1) and the target object (3) are known, and the moving object (3) [sic: should be (1)] receives a work order (24) from a stationary server device (18) and a business application (23) loaded therein, at least to the extent that it is to move toward the position of the target object (3) given in the work order, characterized in that the moving object carries an RFID tag, which measures the distance to the reference points (radio beacons 4-7), and transmits the information via a wireless communication connection (16) to a reader (17) connected to the server (18).

7. The apparatus according to claim 6, characterized in that the work order (24) having the target position (31) and the previously calculated location readings of the target position (31) can be delivered to the object (1) being driven prior to, or at the same time as the execution of the work order (24).

8. The method according to claim 2, characterized in that the target coordinates of every arbitrary target object in the space are stored in advance in a stationary server, that the GPS coordinates of the target object are converted in the server to distance values, such that distances to the stationary radio beacons defined in the space can be calculated from the GPS coordinates as geometric distances, that the measured values calculated in this manner can be transmitted to the object being driven the context of a work order and that the object being driven can calculate for itself, during its drive toward the target object, the deviation, or respectively, the error between the current driving position and the target position, and from this a difference is calculated, which is compared against the threshold value.

9. The method according to claim 2, characterized in that a location reading is calculated in reverse from a known target position of the target object and the GPS position of the moving object, and that furthermore, the (distance) error is continuously calculated in the object being driven, and continuously compared there to the threshold value.

10. The method according to claim 3, characterized in that a location reading is calculated in reverse from a known target position of the target object and the GPS position of the moving object, and that furthermore, the (distance) error is continuously calculated in the object being driven, and continuously compared there to the threshold value.

11. The method according to claim 2, characterized by the following procedural steps:
Step 1: The business application loaded in the server decides that a work order is to be sent to the operator of the moving object.
Step 2: The target location readings (at the target position) are calculated from the GPS coordinates in the stationary server, wherein the work order consists in part for the operator, and in part for the system in the moving object, which regulates the execution of the work order.
Step 3: The work order is transmitted to the moving object.
Step 4: The operator receives a notification on his display that he is to drive in the grid system of the space to a logical position (e.g. track 35, row 18, and elevation 5) of the target object, and execute the work order (e.g. pick up a container) there.
Step 5: After receiving the work order from step 4, the operator begins driving, without waiting for further information, or downloading further data from a server.
Step 6: Continuous distance measurements with respect to the stationary reference points (radio beacons 4-7) are carried out during the drive in the object being driven, and the current errors (between the actual location readings and the target location readings) are calculated in the moving object and compared against the predetermined threshold value.
Step 7: As soon as the object being driven arrives at the location of the target object, the threshold value, in the form of the result of the error distance measurement from step 6, approaches zero; as soon as the threshold value falls below a predetermined value, the operator receives a visual confirmation that he has arrived at the target object.
Step 8: At the same time, the work order (e.g. pick up container) is authorized, and an electronic monitoring with respect to the work order (e.g. loading operation) takes place, in order to prevent the operator from carrying out the wrong work order (e.g. picking up the wrong container).

12. The method according to claim 3, characterized by the following procedural steps:
Step 1: The business application loaded in the server decides that a work order is to be sent to the operator of the moving object.
Step 2: The target location readings (at the target position) are calculated from the GPS coordinates in the stationary server, wherein the work order consists in part for the operator, and in part for the system in the moving object, which regulates the execution of the work order.
Step 3: The work order is transmitted to the moving object.
Step 4: The operator receives a notification on his display that he is to drive in the grid system of the space to a logical position (e.g. track 35, row 18, and elevation 5) of the target object, and execute the work order (e.g. pick up a container) there.
Step 5: After receiving the work order from step 4, the operator begins driving, without waiting for further information, or downloading further data from a server.
Step 6: Continuous distance measurements with respect to the stationary reference points (radio beacons 4-7) are carried out during the drive in the object being driven, and the current errors (between the actual location readings and the target location readings) are calculated in the moving object and compared against the predetermined threshold value.
Step 7: As soon as the object being driven arrives at the location of the target object, the threshold value, in the form of the result of the error distance measurement from step 6, approaches zero; as soon as the threshold value falls below a predetermined value, the operator receives a visual confirmation that he has arrived at the target object.
Step 8: At the same time, the work order (e.g. pick up container) is authorized, and an electronic monitoring with respect to the work order (e.g. loading operation) takes place, in order to prevent the operator from carrying out the wrong work order (e.g. picking up the wrong container).

13. The method according to claim 4, characterized by the following procedural steps:
Step 1: The business application loaded in the server decides that a work order is to be sent to the operator of the moving object.
Step 2: The target location readings (at the target position) are calculated from the GPS coordinates in the stationary server, wherein the work order consists in part for the operator, and in part for the system in the moving object, which regulates the execution of the work order.
Step 3: The work order is transmitted to the moving object.
Step 4: The operator receives a notification on his display that he is to drive in the grid system of the space to a logical position (e.g. track 35, row 18, and elevation 5) of the target object, and execute the work order (e.g. pick up a container) there.
Step 5: After receiving the work order from step 4, the operator begins driving, without waiting for further information, or downloading further data from a server.
Step 6: Continuous distance measurements with respect to the stationary reference points (radio beacons 4-7) are carried out during the drive in the object being driven, and the current errors (between the actual location readings and the target location readings) are calculated in the moving object and compared against the predetermined threshold value.
Step 7: As soon as the object being driven arrives at the location of the target object, the threshold value, in the form of the result of the error distance measurement from step 6, approaches zero; as soon as the threshold value falls below a predetermined value, the operator receives a visual confirmation that he has arrived at the target object.
Step 8: At the same time, the work order (e.g. pick up container) is authorized, and an electronic monitoring with respect to the work order (e.g. loading operation) takes place, in order to prevent the operator from carrying out the wrong work order (e.g. picking up the wrong container).
